(19) United States
(12) Patent Application Publication
(10) Pub. No.: US 2025/0018755 A1
(43) Pub. Date: Jan. 16, 2025

(54) METHOD FOR ASCERTAINING THE COUPLING STATE OF A TRAILER COUPLING, STATE ASCERTAINING ASSEMBLY, AND VEHICLE

(71) Applicant: ZF CV SYSTEMS GLOBAL GMBH, Bern (CH)

(72) Inventor: Janik RICKE, Uetze (DE)

(21) Appl. No.: 18/711,891

(22) PCT Filed: Nov. 1, 2022
(86) PCT No.: PCT/EP2022/080441

§ 371 Date: May 21, 2024

(30) Foreign Application Priority Data
Nov. 25, 2021 (DE) 10 2021 130 863.1

(51) Int. Cl. B60D 1/62; B60D 1/01; B60D 1/28

(52) U.S. Cl. CPC B60D 1/62; B60D 1/015; B60D 1/28

(57) ABSTRACT

A method for ascertaining a coupling state of a trailer coupling between a towing vehicle and a trailer, wherein a pivotal connection between a towing-vehicle coupling element on the towing vehicle and a trailer coupling element on the trailer is established in a locked state of the trailer coupling, the method including ascertaining coupling information, wherein, depending on a position of a locking mechanism of the trailer coupling and/or a jolt of the towing vehicle and/or trailer, the coupling information indicates whether the trailer coupling might be in the locked state. The method further includes ascertaining positioning information, wherein, depending on sensor signals of a wave-based sensor device, the positioning information indicates whether the trailer coupling might be in the locked state. The method further includes ascertaining a coupling outcome, depending on the coupling information and also depending on the positioning information.

### CROSS REFERENCE TO RELATED APPLICATIONS

This application is a U.S. National Phase application under 35 U.S.C. § 371 of International Application No. PCT/EP2022/080441, filed on Nov. 1, 2022, and claims benefit to German Patent Application No. DE 10 2021 130 863.1, filed on Nov. 25, 2021. The International Application was published in German on Jun. 1, 2023 as WO 2023/094123 A1 under PCT Article 21 (2).

### FIELD

The invention relates to a method for ascertaining a coupling state of a trailer coupling, a state-ascertaining arrangement for carrying out the method and a vehicle, in particular a utility vehicle, having a state-ascertaining arrangement of this type.

### BACKGROUND

If a trailer is to be coupled to a towing vehicle via a trailer coupling, i.e. pivotally connected to said towing vehicle, it is necessary to check if the trailer coupling is locked correctly, i.e. whether the trailer coupling is actually in a locked state. Existing systems do this with a camera by using the captured image to directly determine whether a connection is already established. However, in a utility vehicle, the trailer coupling is mounted below the vehicle or below the trailer, which means that it would be necessary to mount an additional camera to see the trailer coupling in its entirety.

Furthermore, position sensors or locking sensors are known, which are used to check whether the respective locking mechanism is closed. However, this is not sufficient to reliably determine whether a pivotal connection is actually established since, in the case of a pin coupling, for example, the towing eye can spring out of the clevis, for example, or the clevis locks before the towing eye is properly seated. In the case of a manually operated vehicle, the driver is able to check manually whether the pivotal connection is actually established. However, this is not possible in a fully automated vehicle and, even in a manually operated vehicle, such a checking step can be omitted by the driver.

To this end, it is known from the prior art according to US 20200361397 A1 to ascertain if a trailer for a car is coupled correctly using a camera, a LiDAR sensor, a radar sensor or an ultrasonic sensor. In the case of a car, the respective sensor system here can detect the coupling elements of the trailer coupling in the manner described. However, this is not always possible in the case of a lorry, so, unlike in US 20200361397A1, it cannot be ascertained whether a correct pivotal connection is established using the respective sensor system alone.

DE 10 2020 103 099 A1 and DE 10 2020 102 667 A1 each describe a coupling assistance system in which a camera is aligned towards the coupling ball in order to control the approach between the towing vehicle and the trailer. A vehicle heading is determined here, along which the vehicle then moves. There is no provision here for validation via one or more sensor signals as to whether the coupling procedure has actually succeeded or as to whether the trailer coupling is actually in a locked position. DE 10 2014 003 953 A1 also describes an assistance system for coupling a trailer to a towing vehicle, wherein, to this end, a camera is used which ascertains the position of the eye on the drawbar of the trailer during the reversing procedure. From this, a trajectory along which the towing vehicle approaches the trailer is ascertained without checking whether the trailer coupling is in the locked state.

DE 10 2019 007 662 A1 furthermore describes how a towing vehicle and a trailer are set at the right height, wherein sensor signals of a camera, a LiDAR sensor a radar sensor or an ultrasonic sensor are used for this purpose. DE 10 2018 122 224 A1 describes a monitoring unit for coupling a towing vehicle and trailer, wherein the vehicle movement is monitored for this purpose. To this end, movement information of the towing vehicle or the trailer are evaluated by a sensor device. However, it is not checked whether correct coupling has taken place.

EP 1 580 043 B1 furthermore describes how, when hitching a drawbar trailer to the towing vehicle, the clevis is monitored by a single sensor device via which a signal signalling the mechanical coupling state of the trailer can be generated. If correct coupling is not established, the brake of the towing vehicle and/or trailer is engaged. EP 0 794 110 B1 furthermore describes a locking announcement via a sensor, which detects when the locking mechanism is in a closed position. In DE 10 2020 115 065, a position of a sensor pin on the trailer coupling is ascertained to ascertain the coupling state.

DE 10 2004 029 129 A1 furthermore describes an image sensor of a camera which monitors the movement of a closure element associated with the trailer coupling. If the closure element suggests that the trailer coupling is locked, braking of the towing vehicle is initiated. If a trailer coupling having a sensor for detecting the opening state of the trailer coupling is used, braking of the towing vehicle can also be initiated if a locked state is ascertained on the basis of this sensor. However, the two sensors are not used in combination with one another here to ascertain the actual coupling state.

### SUMMARY

In an embodiment, the present disclosure provides a method for ascertaining a coupling state of a trailer coupling between a towing vehicle and a trailer, wherein a pivotal connection between a towing-vehicle coupling element on the towing vehicle and a trailer coupling element on the trailer is established in a locked state of the trailer coupling, the method comprising ascertaining coupling information, wherein, depending on a position of a locking mechanism of the trailer coupling and/or a jolt of the towing vehicle and/or a jolt of the trailer, the coupling information indicates whether the trailer coupling might be in the locked state. The method further comprises ascertaining positioning information, wherein, depending on sensor signals of a wave-based sensor device, the positioning information indicates whether the trailer coupling might be in the locked state. The method further comprises ascertaining a coupling outcome, depending on the coupling information and also depending on the positioning information, wherein the coupling outcome indicates whether or not a pivotal connection between the towing vehicle and the trailer is established via the trailer coupling.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b show schematic views of a vehicle with different trailer couplings; and

FIG. 2 shows a flow chart of a method according to an embodiment of the invention.

### DETAILED DESCRIPTION

In an embodiment, the present invention provides a method and a state-ascertaining arrangement with which reliable ascertainment and monitoring of a coupling state of a trailer coupling can take place. A vehicle is also provided.

According to an embodiment of the invention, a method for monitoring or ascertaining a coupling state of a trailer coupling between a towing vehicle and a trailer is therefore provided, wherein a pivotal connection between a towing-vehicle coupling element on the towing vehicle and a trailer coupling element on the trailer is established in a locked state of the trailer coupling, preferably without a distance-altering relative movement between the towing vehicle and the trailer being able to take place, wherein at least the following steps are provided:
ascertaining coupling information, wherein, depending on a position of a locking mechanism of the trailer coupling and/or a jolt of the towing vehicle and/or a jolt of the trailer, the coupling information indicates whether or not the trailer coupling might be in the locked state, wherein the locking mechanism is designed to produce or maintain a pivotal connection between the coupling elements in its closed position when the coupling elements are positioned correctly with respect to one another;
ascertaining positioning information, wherein, depending on sensor signals of a wave-based sensor device, the positioning information indicates whether or not the trailer coupling might be in the locked state, wherein, on the basis of the sensor signals of the wave-based sensor device, position information relating to an object which is detected thereby and is involved, in particular, in establishing the pivotal connection is ascertained and, from this, it is derived whether or not the trailer coupling might be in the locked state; and
ascertaining a coupling outcome depending on the coupling information and also depending on the positioning information, wherein the coupling outcome indicates whether or not a pivotal connection between the towing vehicle and the trailer is established via the trailer coupling or whether the trailer coupling is actually in a locked position.

At least two mutually independent and also differently acting measuring principles are used to validate the coupling state of the trailer coupling. It is thus ensured that the wrong coupling state is not output due to wrongly ascertained coupling information since the correct coupling outcome can only be assumed with a high degree of certainty if the positioning information also suggests the same coupling state. Accordingly, the information—coupling information and positioning information—can be plausibility-checked against each other and only then will a final coupling outcome be output. It is therefore preferably provided that the coupling outcome indicates that a pivotal connection between the towing vehicle and the trailer is highly likely to have been established if, and only if, both the coupling information and the positioning information indicate that the trailer coupling is in the locked state.

A wave-based sensor device is preferably used for this purpose, i.e. a sensor device which evaluates waves or radiation in the visible and invisible wavelength range, for example visible light via a camera, laser radiation in the case of a LiDAR sensor, radar radiation in the case of a radar sensor and ultrasonic radiation in the case of an ultrasonic sensor. All of these wave-based sensor devices enable the ascertainment of position information in relation to an object in the surrounding environment which is involved in the pivotal connection.

It is preferably provided that the ascertainment of the positioning information comprises the steps:
detecting at least one object in a surrounding environment via the wave-based sensor device and outputting sensor signals, wherein the wave-based sensor device is arranged on the towing vehicle or on the trailer, i.e. an image of the object is created and output in the sensor signals for further processing;
ascertaining position information of the detected object, in particular an actual position and/or an actual alignment of the detected object relative to the wave-based sensor device or relative to the towing vehicle or to the trailer on which the wave-based sensor device is arranged, wherein the at least one detected object is the towing vehicle and/or the trailer or an object in the surrounding environment which is connected thereto and which is involved in establishing the pivotal connection, for example the coupling element on the towing vehicle and/or the coupling element on the trailer.

To this end, the wave-based sensor device can be, for example, part of an existing driver assistance system in the vehicle, for example a reversing assistance system, so that further sensor systems do not need to be installed in the vehicle for this plausibility-checking of the pivotal connection through ascertainment of the positioning information. In particular, it is provided here that the coupling elements on the towing vehicle and/or on the trailer are not necessarily located in the detection area of the wave-based sensor device, since it is possible to reconstruct the actual position and/or the actual alignment based on geometrical considerations, e.g. from the actual position and/or the actual alignment of the towing vehicle or the trailer. In general, it can therefore be provided that, in the event that an object in the surrounding environment which is involved in establishing the pivotal connection cannot be detected, or cannot be detected in its entirety, by the wave-based sensor device, the position information of this object is derived from the position information relating to a detected object in the surrounding environment which is connected thereto. Therefore, a wave-based sensor device which is able to see the trailer coupling or all of the coupling elements in its/their entirety does not have to be explicitly provided in the region of the trailer coupling.

It is preferably furthermore provided that the ascertainment of the positioning information further comprises the steps:
reading in a setpoint position associated with the detected object and/or a setpoint alignment associated with the detected object, wherein the setpoint position and/or the setpoint alignment indicate how, in the locked state of the trailer coupling, the respective associated object is arranged, positioned and/or aligned relative to the wave-based sensor device or relative to the towing vehicle or to the trailer on which the wave-based sensor device is arranged;
ascertaining the positioning information depending on
whether the ascertained actual position for the respective detected object corresponds to or deviates from the setpoint position for the respective detected object, and/or
whether the ascertained actual alignment for the respective detected object corresponds to or deviates from the setpoint alignment for the respective detected object, wherein the positioning information preferably indicates that the trailer coupling might be in the locked state if the ascertained actual position corresponds to the setpoint position and/or the ascertained actual alignment corresponds to the setpoint alignment for the respective detected object. Therefore an actual/setpoint comparison which can be carried out in a simple manner advantageously takes place to ascertain or derive the coupling state from the sensor signals of the wave-based sensor device or from the image of the object.

It can furthermore be provided that the ascertainment of the positioning information furthermore comprises the step:
ascertaining the positioning information depending on
whether and to what extent the ascertained actual position and/or the ascertained actual alignment and/or the ascertained position information of the detected object change if the towing vehicle (or the trailer) moves, and/or, with the same effect,
whether a relative movement between the towing vehicle and the trailer is concluded from the ascertained actual position and/or the ascertained actual alignment and/or the ascertained position information,
wherein the positioning information preferably indicates that the trailer coupling might be in the locked state if the ascertained actual position and/or the ascertained actual alignment and/or the ascertained position information of the detected object do not change if the towing vehicle moves, and/or there is no relative movement between the towing vehicle and the trailer. It can therefore also be advantageously concluded from the sensor signals of the wave-based sensor device whether the towing vehicle is still able to move relative to the trailer, which can be used to validate the coupling information, i.e. to confirm or not confirm this.

It is furthermore provided that an actual distance and/or an actual angle are ascertained from the actual position and/or the actual orientation and/or from the position information of a detected object, wherein the actual distance characterizes how far away the coupling element on the towing vehicle is from the coupling element on the trailer, and the actual angle characterizes how the coupling element on the towing vehicle is aligned with respect to the coupling element on the trailer. It can also be geometrically determined whether or not a locked position is established or might be established, wherein, to this end, it is additionally provided that the positioning information indicates that the trailer coupling might be in the locked state if the actual distance has reached a setpoint distance or exceeds this. It can therefore already be ascertained whether the coupling state might be established based on the distance, wherein, to this end, as already stated, the respective coupling element does not necessarily have to be in the detection area of the sensor device since an actual distance between the rear of the towing vehicle and the front of the trailer can already suggest the distance between the two coupling elements based on geometrical considerations. Reconstruction of the relevant actual distance is therefore also an option for evaluating the coupling state.

It can preferably be additionally provided that, in the event that the actual angle exceeds a limit angle, the positioning information indicates that the trailer coupling is not in the locked state, wherein the limit angle is selected such that, if the limit angle is exceeded, it is no longer possible to couple the coupling element on the trailer to the coupling element on the towing vehicle. It can advantageously also be checked whether coupling is even possible based on the given position information.

It is preferably furthermore provided that the coupling information indicates that the trailer coupling might be in the locked state if, from a movement of the locking mechanism of the trailer coupling and/or from a control signal of an electrical actuating mechanism for actuating the locking element, it follows that the locking mechanism is in a closed position. Information about the coupling state can therefore be derived in a simple manner from a coupling or locking sensor located on one of the coupling elements.

It can preferably furthermore be provided that, to ascertain the first coupling information, the jolt of the towing vehicle and/or the jolt of the trailer can be ascertained via
a velocity sensor on the towing vehicle and/or on the trailer and/or
an acceleration sensor on the towing vehicle and/or on the trailer. Such a velocity or acceleration sensor can be, for example, a wheel speed sensor, preferably an active wheel speed sensor, which detects the rotational speeds at the respective wheels, wherein the velocity or the acceleration can be derived from the rotational speeds. However, other sensors can also be provided.

Existing sensors can therefore be used in order to conclude a jolt which can likewise suggest whether coupling has taken place. In the event of contact between the coupling elements, an abrupt change in the velocity or the acceleration normally occurs at the towing vehicle or at the trailer. It is therefore preferably provided that the coupling information indicates that the trailer coupling might be in the locked state if the jolt of the towing vehicle and/or the jolt of the trailer suggest that the coupling element on the trailer has made contact with the coupling element on the towing vehicle, for example if a specified jolt limit value for the respective jolt is reached or exceeded.

It is preferably furthermore provided that the coupling information and the positioning information are ascertained in succession or in parallel with one another. Therefore, depending on the application, the sequence in which the information is ascertained and evaluated can be decided in a flexible manner. It can preferably be provided here that the positioning information is only ascertained if the coupling information indicates that the trailer coupling might be in the locked state, or vice versa. As a result, it can be advantageously achieved that data recording and evaluation initially only has to take place for one of the options and only then does further evaluation of data take place for plausibility-checking or validation purposes.

It is preferably furthermore provided that, if both the coupling information and the positioning information indicate that the trailer coupling might be in the locked state, it is additionally ascertained whether the jolt of the towing vehicle and/or the jolt of the trailer vehicle reach or exceed a specified jolt threshold value, in particular within a time offset after the towing vehicle has started to move, and the coupling outcome indicates that a pivotal connection between the towing vehicle and the trailer is established if the specified jolt threshold value has been reached. Accordingly, after a coupling state is validated, it can also be ascertained again whether play is included in the coupling with a time offset after the towing vehicle of the trailer has started moving.

According to an embodiment of the invention, a state-ascertaining arrangement for ascertaining a coupling state of a trailer coupling between a towing vehicle and a trailer is furthermore provided, which at least comprises:
a position sensor for ascertaining a position of a locking mechanism of the trailer coupling, and/or
an acceleration sensor on the towing vehicle and/or on the trailer for ascertaining a jolt of the towing vehicle and/or a jolt of the trailer from the time derivative of the respective acceleration, and/or
a velocity sensor on the towing vehicle and/or on the trailer for ascertaining a jolt of the towing vehicle and/or a jolt of the trailer from the second time derivative of the respective velocity,
a wave-based sensor device for detecting objects in a surrounding environment and for outputting sensor signals, and
a state-ascertaining unit, wherein the state-ascertaining unit is designed to execute a method according to an embodiment of the invention.

According to an embodiment of the invention, a vehicle, in particular a utility vehicle, is furthermore provided, which can preferably be operated autonomously and which comprises a towing vehicle and a trailer, wherein a pivotal connection between a towing-vehicle coupling element on the towing vehicle and a trailer coupling element on the trailer can be established via a trailer coupling if a locking mechanism of the trailer coupling is brought into a closed position, wherein the vehicle furthermore has a state-ascertaining arrangement according to an embodiment of the invention for ascertaining a coupling state of the trailer coupling. The trailer coupling here can preferably be designed as a pin coupling, in which, to establish a pivotal connection, an eye on a drawbar as a coupling element on the trailer can be held in a clevis as a coupling element on the towing vehicle via a coupling pin as a locking mechanism, or—designed as a fifth wheel coupling, in which, to establish a pivotal connection, a kingpin as a coupling element on the trailer can be held on a fifth wheel plate as a coupling element on the towing vehicle via a coupling dog as a locking mechanism. Flexible use is therefore provided for different coupling types.

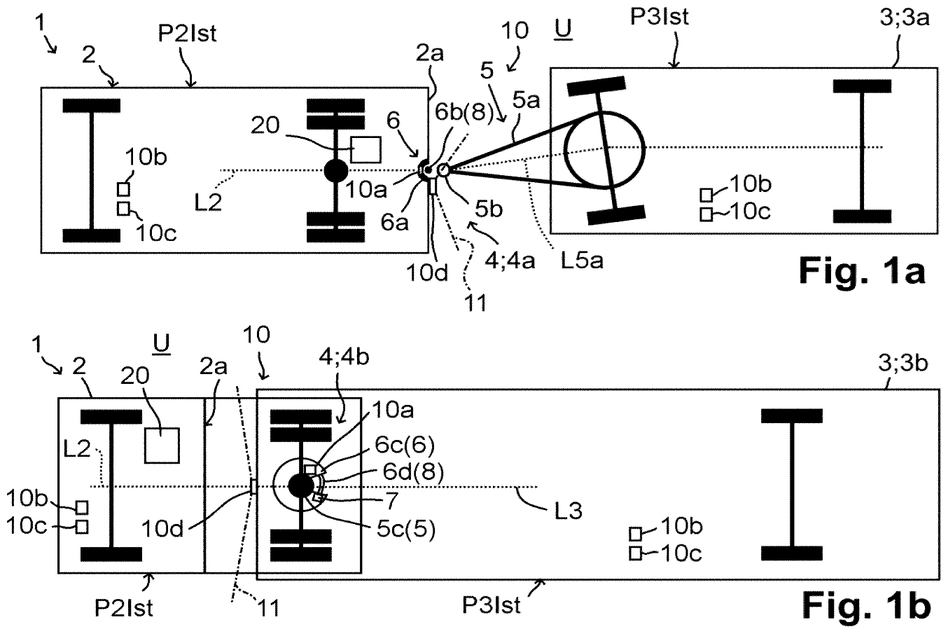

FIG. 1a, b show schematic views of a vehicle with different trailer couplings; and

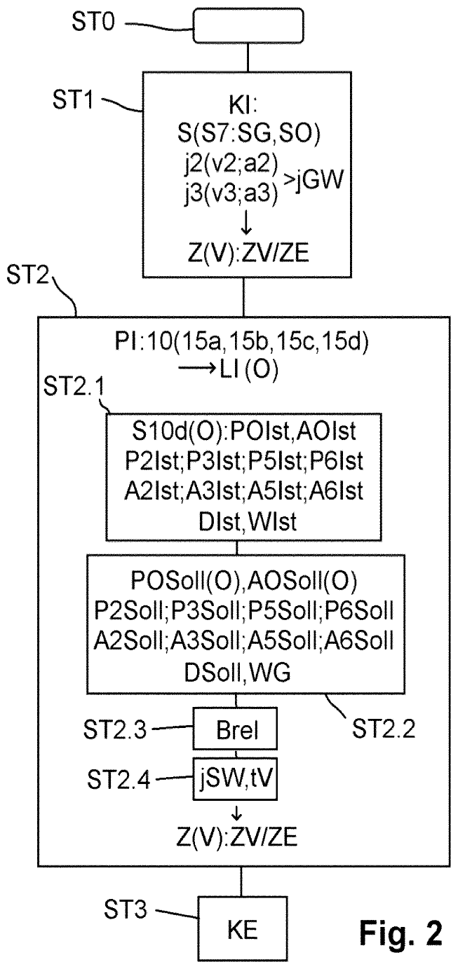

FIG. 2 shows a flow chart of a method according to an embodiment of the invention.

FIGS. 1a and 1b both show, in a schematic illustration, a vehicle 1 which comprises a towing vehicle 2 and a trailer 3 coupled to said towing vehicle, wherein a pivotal connection V between the two is established via a trailer coupling 4. In FIG. 1, the trailer 3 is a drawbar trailer 3a with a drawbar 5a and an eye 5b which is arranged on said drawbar as a coupling element 5 on the trailer and a clevis 6a having coupling pins 6b as a coupling element 6 on the towing vehicle. The trailer coupling 4 is accordingly designed in the manner of a pin coupling 4a, in which the eye 5b of the drawbar 5a is held in the clevis 6a via the coupling pin 6b as a locking mechanism 8 and a pivotal connection V between the drawbar trailer 3a and the towing vehicle 2 is thus established. Depending on the design of the drawbar trailer 3a, the drawbar 5a here can be connected to the trailer frame in a rigid manner (rigid drawbar) or in an articulated manner (centre pivot plate).

In FIG. 1b, the trailer 3 is a fifth wheel trailer 3b with a kingpin 5c as a coupling element 5 on the trailer and a fifth wheel plate 6c having a coupling dog 6d as a coupling element 6 on the towing vehicle. The trailer coupling 4 is accordingly designed in the manner of a fifth wheel coupling 4b, in which the kingpin 5c is held on the fifth wheel plate 6c via the coupling dog 6d as a locking mechanism 8 and a pivotal connection V between the fifth wheel trailer 3b and the towing vehicle 2 (semi-trailer) is thus established. The two vehicles 1 in FIGS. 1a and 1b differ accordingly, in particular in the manner of the trailer coupling 4.

In both illustrated variants, the trailer coupling 4 can be in a locked state ZV or in an unlocked state ZE, wherein these two coupling states Z can be established via an adjustment or a movement of the locking mechanism 8, i.e. the coupling pin 6b (pin coupling 4a) or the coupling dog 6d (fifth wheel coupling 4b), e.g. by means of an electrical actuating mechanism 7. With correct positioning of the eye 5b in the clevis 6a or of the kingpin 5c in the fifth wheel plate 6c, a distance-altering relative movement between the respective trailer 3 and the towing vehicle can be prevented in the locked state ZV of the trailer coupling 4 or accordingly enabled in the unlocked state ZE of the trailer coupling 4. A pivoting movement and a relative movement between the trailer 3 and the towing vehicle 2 which occur due to wear on the trailer coupling 4 should not be regarded as distance-altering relative movements within the context of the present disclosure.

According to an embodiment of the invention, the coupling state Z, which characterizes the state of the pivotal connection V established between the towing vehicle 2 and the trailer 3 via the trailer coupling 4 can be monitored or determined by a state-ascertaining unit 20 in a state-ascertaining arrangement 10. Two pieces of information ascertained independently of one another—coupling information KI and positioning information PI—are used as follows for this purpose:

The state-ascertaining arrangement 10 can comprise, for example, a position sensor 10a, via which it is possible to directly ascertain or directly monitor the position S in which the locking mechanism 8 (coupling pin 6b or coupling dog 6d) finds itself, i.e. in a closed position SG or in an open position SO. In the closed position SG in each case, the locking mechanism 8 is capable of producing and maintaining a pivotal connection V between the coupling element 5 on the trailer and the coupling element 6 on the towing vehicle insofar as the eye 5b or the kingpin 5c are correctly positioned in the clevis 6a or on the fifth wheel plate 6c (corresponding to the locked state ZV of the trailer coupling 4). On the other hand, in the open position SO, this pivotal connection V is not maintained (corresponding to the unlocked state ZE of the trailer coupling 4). To this end, the position sensor 10a can, for example, monitor the movement of the locking mechanism 8, i.e. the coupling pin 6b or the coupling dog 6d, and/or actuating signals S7 of the electrical actuating mechanism 7. Depending on the position S; SG, SO ascertained by the position sensor 10a, the coupling state Z of the trailer coupling 4 can be derived in the state-ascertaining unit 20.

According to an alternative or additional embodiment, it can be provided that the state-ascertaining arrangement 10 comprises or has an acceleration sensor 10b and/or a velocity sensor 10c, which are arranged on the towing vehicle 2 and/or on the trailer 3, wherein these can already be present in the vehicle 1, for example as part of another vehicle unit. From the towing-vehicle acceleration a2 and/or trailer acceleration a3 and/or towing vehicle velocity v2 and/or trailer velocity v3 measured by the acceleration sensor and/or velocity sensor, a jolt j2 of the towing vehicle and/or a jolt j3 of the trailer can be ascertained (first time derivative of the respective acceleration a2, a3, second time derivative of the respective velocity v2, v3).

The acceleration sensor 10b and/or the velocity sensor 10c, which are illustrated merely schematically in FIG. 1, can be designed, for example, as wheel speed sensors on the individual wheels of the towing vehicle 2 or the trailer 3, which measure the rotational speeds of the wheels, from which the velocity or the acceleration is produced. Existing sensors in the vehicle can therefore be used.

If a brief change in velocity or acceleration or a corresponding jolt j2, j3 which reaches or exceeds a previously specified jolt limit value jGW are detected, it can be concluded in the state-ascertaining unit 20 that this is the result of the coupling element 5 on the trailer coming into contact with the coupling element 6 on the towing vehicle. The coupling state Z of the trailer coupling 4 can also be derived from this in the state-ascertaining unit 20, wherein a locked state ZV of the trailer coupling 4 is only expected if the eye 5b or the kingpin 5c has made contact with the clevis 6a or the fifth wheel plate 6c in a correct position.

The coupling information KI which is used in a method according to the disclosure is generated by at least one of these described options, i.e. via the position sensor 10a and/or the acceleration sensor 10b and/or the velocity sensor 10c. The coupling information KI only indicates that the trailer coupling 4 might be in the locked state ZV, since correct positioning of the coupling elements 5 may not be checked via these options. The coupling information KI can be ascertained using a plurality of the said options, in that the position S; SG, SO of the locking mechanism 8, which is monitored or determined via the position sensor 10a, is plausibility-checked with the jolt j2, j3 which is monitored or determined via the acceleration sensor 10b and/or velocity sensor 10c in order to obtain reliable coupling information KI.

Using coupling information KI ascertained in this way, the state-ascertaining unit 20 is therefore still unable to reliably determine the actual coupling state Z of the trailer coupling 4. This is due to the fact that it cannot be ensured that the eye 5b is positioned correctly in the clevis 6a, or that the kingpin 5c is positioned correctly in the fifth wheel plate 6c, when the coupling pin 6b or the coupling dog 6d are brought into the closed position SG. A correspondingly determined jolt j2, j3 which is above the jolt limit value jGW can lead to an incorrectly derived coupling state Z in the case of incorrect positioning. For further plausibility-checking of the coupling state Z of the trailer coupling 4, the state-ascertaining unit 20 therefore additionally uses the sensor signals S10d of a wave-based sensor device 10d, which is arranged on the towing vehicle 2 or on the trailer 3 and can be used to ascertain positioning information PI.

By way of example, the wave-based sensor device 10d can be formed by a camera 15a or comprise such a camera, wherein the camera 15a is capable of capturing an object O in its surrounding environment U in a spatially resolved manner via an image sensor, which detects electromagnetic radiation emitted/reflected by the object O, in particular in the visible range, and generating and outputting the sensor signals S10d accordingly. Alternatively or in addition to the camera 15a, a LiDAR sensor 15b can be provided, which scans the surrounding environment U using laser beams and detects reflected laser radiation so that an object O in the surrounding environment U can be “imaged” in a spatially resolved manner. Comparable imaging principles based on reflection of waves or radiation can be realized using a radar sensor 15c and/or an ultrasonic sensor 15d with which objects O in the surrounding environment U can be scanned. These wave- or radiation-based imaging principles are based on ascertaining a distance from an object point on the respective object O in the surrounding environment U, towards which the respective sensor 15b, 15c, 15c is aligned, via a travel time measurement for the respective radiation. If the distances from a plurality of object points on an object O are ascertained by changing the alignment of the respective sensor 15b, 15c, 15d (scanning), an image of the respective object O can be generated from this.

The state-ascertaining unit 20 is therefore capable of using an “image” of an object O in the surrounding environment U which is involved in establishing the pivotal connection V, i.e. the towing vehicle 2 and/or the respective trailer 3, to validate the coupling state 2 depending on the generated and output sensor signals S10d of the sensor device 10d. If, as illustrated in FIG. 1a, the wave-based sensor device 10d is installed on the towing vehicle 2, its detection area 11 is aligned in particular rearwards in order to be able to detect a trailer 3 located there. To this end, the wave-based sensor device 10d can be arranged on the rear 2a of the towing vehicle 2, for example as part of an existing driver assistance system, for example a reversing assistance system. However, as illustrated in FIG. 1b, the wave-based sensor device 10d can also be installed on the trailer 3, wherein its detection area 11 can then be aligned forwards, in particular towards the towing vehicle 2, in order to be able to detect the towing vehicle 2.

This enables the state-ascertaining unit 20 to ascertain an actual position P3Ist of the trailer 3 and/or an actual alignment A3Ist of the trailer 3, e.g. relative to the sensor device 10d on the towing vehicle 2, from the sensor signals S10d of the sensor device 10d. When the sensor device 10d is arranged on the trailer 3, an actual position P2Ist of the towing vehicle 2 and/or an actual alignment A2Ist of the towing vehicle 2, e.g. relative to the sensor device 10d on the trailer 3, can be evaluated accordingly from the sensor signals S10d of the sensor device 10d. Furthermore, however, an actual position P5Ist and/or an actual alignment A5Ist of the coupling element 5 on the trailer, e.g. the drawbar 5a, relative to a sensor device 10d on the towing vehicle 2, and an actual position P6Ist and/or an actual alignment A6Ist of the coupling element 6 on the towing vehicle, e.g. the clevis 6a or the fifth wheel plate 6d, relative to a sensor device 10d on the trailer 3 can also be evaluated from the sensor signals S10d if the said coupling elements are located in the detection area 11 of the sensor device 10d.

The actual position POIst of the respective detected object O (2, 3, 4, 5) involved in establishing the pivotal connection can be described here by one or more specified reference points on the respective detected object O. The actual alignment AOIst of the respective detected object O (2, 3, 4, 5) relates, for example, to a longitudinal centre axis L2, L3 of the detected towing vehicle 2 or the detected trailer 3. The respective object O can therefore be reconstructed accordingly from the actual position POIst and the actual alignment AOIst. Amongst other things, the sensor position and the sensor orientation of the sensor device 10d on the towing vehicle 2 or on the trailer 3, e.g. relative to a specified reference point or to the longitudinal centre axes L2, L3 of the towing vehicle 2 or of the trailer 3, are also taken into account here, wherein this follows from a previous calibration of the sensor device 10d.

Position information L1 relating to the respective detected object O in the surrounding environment U which is involved in establishing the pivotal connection, i.e. in particular the towing vehicle 2, the trailer 3 and the coupling elements 5, 6, can be generally obtained from the sensor signals S10d of the sensor device 10d, wherein the position information L1 reveals how the trailer 3 is positioned relative to the towing vehicle 2 or how the coupling element 5 on the trailer is positioned relative to the coupling element 6 on the towing vehicle. To this end, corresponding imaging algorithms are used, for example edge detection, in order to be able to clearly identify the towing vehicle 2 or the trailer 3 or the coupling elements 5, 6 based on the sensor signals S10d.

If the respective coupling element 5, 6 here is not located directly or entirely in the detection area 11 of the sensor device 10d, the actual position P5Ist, P6Ist and/or the actual alignment A5Ist, A6Ist of the respective coupling element 5, 6 can also be derived based on geometrical considerations if these coupling elements are rigidly or immovably fastened on the towing vehicle 2 or on the trailer 3. If the sensor device 10d is arranged on the towing vehicle 2, for example, and the eye 5b and possibly also part of the drawbar 5a cannot be detected (or can no longer be detected) by the sensor device 10f, the actual position P5Ist and/or the actual alignment A5Ist of the drawbar 5a including the eye 5b (coupling element 5 on the trailer) can also be reconstructed based on the specified design and the dimensions of the drawbar 5a. The design and the dimensions of the drawbar 5a here are stored, for example, in the state-ascertaining unit 20 or they can be accessed in another manner, for example from previous images.

If a rigid drawbar or a kingpin 5c is present, which are each rigidly fastened to the trailer 3, and these cannot be detected (or can no longer be detected) by the sensor device 10, the actual position P5Ist and/or the actual alignment A5Ist of these coupling elements 5 on the trailer can also be derived, for example, from the ascertained actual position P3Ist and/or the actual alignment A3Ist of the trailer 3. In this case, the design and the dimensions of the respective coupling element 5 on the trailer and also the fixed position thereof on the trailer 3 are also known and can be used by the state-ascertaining unit 20 for further geometrical considerations.

As described, the actual position POIst or the actual alignment AOIst of the respective detected object O relative to the sensor device 10d can be indicated. Moreover, from the geometrical considerations, taking into account the sensor position and the sensor orientation, it is also possible to derive how the respective detected object O is positioned relative to the coupling element 5, 6 of the vehicle part on which the sensor device 10d is arranged. Accordingly, for example, the actual position P5Ist and the actual orientation A5Ist of the drawbar 5a including the eye 5b relative to the clevis 6a can be indicated if the sensor device 10d is located on the towing vehicle 2 and has been previously calibrated accordingly. This also applies analogously when the sensor device 10d is arranged on the trailer 3, wherein, in this case, the actual position P6Ist and the actual orientation A6Ist of the clevis 6a with respect to the drawbar 5a or to the eye 5b can be derived from geometrical considerations. The same applies in an embodiment of the trailer coupling 4 as a fifth wheel coupling 4b.

Using these described components in the vehicle 1, the coupling state Z of the trailer coupling 4 according to FIG. 2 can be monitored or determined by the state-ascertaining unit 20 as follows:

In an initial step ST0, the process is initialised, for example at the start of a coupling procedure in which the trailer 3 is to be coupled to the towing vehicle 2. In a first step ST1, the coupling information KI is ascertained, i.e. whether the trailer coupling 4 might be in a locked state ZV based on the monitored or determined position S; SG, SO of the coupling pin 6b or the coupling dog 6d (via the position sensor 190a) and/or based on the monitored jolt j2, j3 (via the acceleration sensor 10b and/or the velocity sensor 10c), if this jolt reaches or exceeds the specified jolt limit value jGW, as can be derived in the manner described above. If this is not the case, the process waits until this is the case.

If it is derived in the first step ST1 that the trailer coupling 4 might be in a locked state ZV, this is validated or checked in the state-ascertaining unit 20 via the wave-based sensor device 10d in a second step ST2, in that the positioning information PI is ascertained independently of the coupling information KI. To this end, in a first intermediate step ST2.1, the actual position POIst and/or the actual alignment AOIst of the respective object O (towing vehicle 2 or trailer 3) or the respective coupling element 5, 6 is ascertained or evaluated in the manner described above.

In a second intermediate step ST2.2, the ascertained actual position POIst and/or the ascertained actual alignment AOIst of the respective object O is compared with a specified setpoint position POSoll or a setpoint alignment AOSoll for the respective object O in order to derive the positioning information PI from this, which likewise reveals whether the trailer coupling 4 might be in the locked state ZV. Based on the position information LI, it is therefore checked whether the towing vehicle 2 or the trailer 3 or the respective coupling element 5, 6 is aligned and positioned in a way which would be expected for the locked state ZV of the trailer coupling 4. The respective setpoint position POSoll or the setpoint alignment AOSoll of the respective object O is therefore selected or specified in such a way that, in the case of a pin coupling 4a, the eye 5b on the drawbar 5a is positioned and aligned correctly in the clevis 6a or, in the case of a fifth wheel coupling 4b, the kingpin 5c is positioned and aligned correctly in the fifth wheel plate 6c.

For the comparison, it is possible to select the setpoint position POSoll or setpoint alignment AOSoll which is associated with a visible or sufficiently visible object O. Therefore, if the kingpin 5c or the eye 5b or part of the drawbar 5a are not visible to a sensor device 10d on the towing vehicle 2, the setpoint position P3Soll of the trailer 3 is used for a comparison with the actual position P3Ist of the trailer 3, from which it can likewise be evaluated whether the kingpin 5c rigidly connected thereto or the eye 5b or the drawbar 5a are positioned or aligned correctly relative to the fifth wheel plate 6c or the clevis 6a. This applies analogously to the clevis 6a or the fifth wheel plate 6c which are not visible to a sensor device 10d on the trailer 3 and whereof the correct positioning and alignment can be derived from a setpoint/actual comparison of the position of the towing vehicle 2.

Within the context of such a setpoint/actual comparison, from which the positioning information PI stems, it can also be provided, for example, that the trailer 3 is detected via the sensor device 10d and an actual distance DIst between a reference point on the drawbar Sa as a coupling element 5 on the trailer and a reference point on the towing vehicle 2, for example the clevis 6a as a coupling element 6 on the towing vehicle, are ascertained from the actual position P3Ist and the actual orientation A3Ist. A locked state ZV can be concluded here if the actual distance DIst has reached a setpoint distance DSoll, which stems from the specified setpoint position P3Soll or setpoint alignment A3Soll of the trailer 3. To also take into account the alignment of the trailer 3 or the drawbar 5a here, an actual angle WIst between a longitudinal centre axis L5a of the drawbar 5a and the longitudinal centre axis L2 of the towing vehicle 2 can also be ascertained from the actual position P3Ist and the actual orientation A3Ist of the trailer 3. Depending on this, it can be additionally checked, for example, whether a limit angle WG is exceeded, i.e. the angle WIst is too acute to be able to bring about a locked state ZV at all. A supposedly locked state ZV ascertained in the first step ST1 can thus also be checked or validated.

If time-based monitoring of the sensor signals S10d by the state-ascertaining unit 20 takes place, it can be additionally checked in a third intermediate step ST2.3 whether and to what extent the actual position POIst and/or the actual alignment AOIst change after it was already determined in the first step ST1 that the trailer coupling 4 might be in a locked state ZV and/or a correspondence with the setpoint position POSoll and/or setpoint orientation AOSoll of the respective object O was also determined in the second intermediate step ST2.2. It can therefore be checked whether a relative movement Brel between the towing vehicle 2 and the trailer 3 occurs during the coupling procedure, which suggests that a locked state ZV was incorrectly assumed or that there is another defect. In this case, braking of the towing vehicle 2 should be initiated to avoid damage.

After it was already determined in the first step ST1 that the trailer coupling 4 might be in a locked state ZV, and/or a correspondence with the setpoint position POSoll and/or setpoint orientation AOSoll of the respective object O was also determined in the second intermediate step ST2.2, it can furthermore be checked in a fourth intermediate step ST2.4 whether the above-described jolt j2, j3 of the towing vehicle 2 and/or of the trailer 3 reaches or exceeds a specified jolt threshold value jSW after the towing vehicle 2 has started to move. If the trailer coupling 4 is actually in a locked state ZV, it is to be expected that, after the towing vehicle 2 moves off, the trailer 3 will be pulled along within a time delay tV of, for example, a maximum of 2s, preferably a maximum of 1.5s, which is perceptible as a short sudden increase in the jolt j2, j3 within the time delay tV. The time delay tV is specified such that even a slight play in the coupling connection is taken into account, which is why the trailer 3 is not pulled along immediately. If this sudden increase to or above the jolt threshold value jSW cannot be ascertained, this is not indicative of an unlocked state ZE of the trailer coupling 4, or if this increase to or above the jolt threshold value jSW is ascertained, a previously supposedly ascertained locked state ZV can be confirmed. The intermediate step ST2.4 can essentially also take place later, in particular also between the second step ST2 and the third step ST3 in FIG. 3, in order to check an ascertained coupling state Z.

If a previously supposedly ascertained locked state ZV is not confirmed or ascertained in this way (intermediate step ST2.4) or in another way within the context of methods according to the disclosure, a brake on the towing vehicle 2 and possibly also on the trailer 3 can be engaged, for example, to avoid damage to lines which are possibly already connected.

If a locked state ZV is also concluded in this way in the second intermediate step ST2.2 (actual=setpoint) and/or the third intermediate step ST2.3 (Brel=0) and/or the fourth intermediate step ST2.4 (j2, j3>=jSW), in a third step ST3, it is output as the coupling outcome KE that a correct pivotal connection V is highly likely to have been established via the trailer coupling 4 based on the mutually independently ascertained coupling information KI and positioning information PI. The vehicle 1 may then start its journey. However, if this is not the case, further correction steps are possibly required, in which the actual alignment AOIst and/or the actual position POIst of the respective object O is corrected and/or manual control takes place. During or after this, it can be checked again in the said method steps ST1, ST2, ST2.2, ST2.3, ST2.4, ST3 whether the pivotal connection V is correctly established by ascertaining the coupling information KI and the positioning information PI.

It is also possible to deviate from the described sequence in which the coupling information KI is ascertained before the positioning information PI. Accordingly, it is also provided to ascertain the positioning information PI through continuous time-based monitoring of the surrounding environment and to then ascertain the coupling information KI if it is derived from the positioning information PI that a locked state ZV might be established. However, both pieces of information KI, PI can also be checked continuously in parallel with one another.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE SIGNS (PART OF THE DESCRIPTION)

| | |
|---|---|
| 1 | Vehicle |
| 2 | Towing vehicle |
| 2a | Rear of the towing vehicle 2 |
| 3 | Trailer |
| 3a | Drawbar trailer |
| 3b | Fifth wheel trailer |
| 4 | Trailer coupling |
| 4a | Pin coupling |
| 4b | Fifth wheel coupling |
| 5 | Coupling element on the trailer |
| 5a | Drawbar |
| 5b | Eye |
| 5c | Kingpin |
| 6 | Coupling element on the towing vehicle |
| 6a | Clevis |
| 6b | Coupling pin |
| 6c | Fifth wheel plate |
| 6d | Coupling dog |
| 7 | Electrical actuating mechanism |
| 8 | Locking mechanism |
| 10 | State-ascertaining arrangement |
| 10a | Position sensor |
| 10b | Acceleration sensor |
| 10c | Velocity sensor |
| 10d | Wave-based sensor device |
| 11 | Detection area of the wave-based sensor device |
| 15a | Camera |
| 15b | LiDAR sensor |
| 15c | Radar sensor |
| 15d | Ultrasonic sensor |
| 20 | State-ascertaining unit |
| a2 | Towing-vehicle acceleration |
| a3 | Trailer acceleration |
| AOIst | Actual alignment of an object O |
| A2Ist | Actual alignment of the towing vehicle 2 |
| A3Ist | Actual alignment of the trailer 3 |
| A5Ist | Actual alignment of the coupling element 5 on the trailer |
| A6Ist | Actual alignment of the coupling element 6 on the towing vehicle |
| Brel | Relative movement |
| DIst | Actual distance |
| DSoll | Setpoint distance |
| j2 | Jolt of the towing vehicle |
| j3 | Jolt of the trailer |
| jGW | Jolt limit value |
| jSW | Jolt threshold value |
| KE | Coupling outcome |
| KI | Coupling information |
| L2 | Longitudinal centre axis of the towing vehicle 2 |
| L3 | Longitudinal centre axis of the trailer 3 |
| L5a | Longitudinal centre axis of the drawbar 5a |
| LI | Position information |
| O | Object |
| POIst | Actual position of the object O |
| P2Ist | Actual position of the towing vehicle 2 |
| P3Ist | Actual position of the trailer 3 |
| P5Ist | Actual position of the coupling element 5 on the trailer |
| P6Ist | Actual position of the coupling element 6 on the towing vehicle |
| PI | Positioning information |
| S | Position of the locking mechanism |
| S7 | Actuating signal |
| S10d | Sensor signal |
| SG | Closed position |
| SO | Open position |
| tV | Time offset |
| U | Surrounding environment |
| V | Pivotal connection |
| v2 | Towing-vehicle velocity |
| v3 | Trailer velocity |
| WIst | Actual angle |
| WG | Limit angle |
| Z | Coupling state of the trailer coupling 4 |
| ZE | Unlocked state of the trailer coupling 4 |
| ZV | Locked state of the trailer coupling 4 |
| ST0, ST1, ST2, ST2.1, | Steps of the method |
| ST2.2, ST2.3, ST2.4, ST3 | |

1. A method for ascertaining a coupling state of a trailer coupling between a towing vehicle and a trailer, wherein a pivotal connection between a towing-vehicle coupling element on the towing vehicle and a trailer coupling element on the trailer is established in a locked state of the trailer coupling, the method comprising:
ascertaining coupling information, wherein, depending on a position of a locking mechanism of the trailer coupling and/or a jolt of the towing vehicle and/or a jolt of the trailer, the coupling information indicates whether the trailer coupling might be in the locked state;
ascertaining positioning information, wherein, depending on sensor signals of a wave-based sensor device, the positioning information indicates whether the trailer coupling might be in the locked state; and
ascertaining a coupling outcome, depending on the coupling information and also depending on the positioning information, wherein the coupling outcome indicates whether or not a pivotal connection between the towing vehicle and the trailer is established via the trailer coupling.

2. The method according to claim 1, wherein the ascertainment of the positioning information comprises:
detecting at least one object in a surrounding environment via the wave-based sensor device and outputting sensor signals, wherein the wave-based sensor device is arranged on the towing vehicle or on the trailer; and
ascertaining position information of the detected object, the position of the detected object including an actual position and/or an actual alignment of the detected object relative to the wave-based sensor device or relative to the towing vehicle or to the trailer on which the wave-based sensor device is arranged,
wherein the at least one detected object is the towing vehicle and/or the trailer or an object in the surrounding environment which is connected thereto and which is involved in establishing the pivotal connection.

3. The method according to claim 2, wherein the ascertainment of the positioning information furthermore comprises:
reading in a setpoint position associated with the detected object and/or a setpoint alignment associated with the detected object, wherein the setpoint position and/or the setpoint alignment indicate how, in the locked state of the trailer coupling, the respective associated object is arranged, positioned and/or aligned relative to the wave-based sensor device or relative to the towing vehicle or to the trailer on which the wave-based sensor device is arranged; and
ascertaining the positioning information depending on;
whether the ascertained actual position for the respective detected object corresponds to or deviates from the setpoint position for the respective detected object, and/or
whether the ascertained actual alignment for the respective detected object corresponds to or deviates from the setpoint alignment for the respective detected object, wherein the positioning information preferably indicates that the trailer coupling might be in the locked state if the ascertained actual position corresponds to the setpoint position and/or the ascertained actual alignment corresponds to the setpoint alignment for the respective detected object.

4. The method according to claim 2, wherein the ascertainment of the positioning information further comprises:
ascertaining the positioning information depending on:
whether and to what extent the ascertained actual position and/or the ascertained actual alignment and/or the ascertained position information of the detected object change if the towing vehicle moves, and/or
whether a relative movement between the towing vehicle and the trailer is concluded from the ascertained actual position and/or the ascertained actual alignment and/or the ascertained position information,
wherein the positioning information indicates that the trailer coupling might be in the locked state if the ascertained actual position and/or the ascertained actual alignment and/or the ascertained position information of the detected object do not change if the towing vehicle moves, and/or there is no relative movement between the towing vehicle and the trailer.

5. The method according to claim 2, wherein, in the event that an object in the surrounding environment cannot be detected, or cannot be detected in its entirety, by the wave-based sensor device, the position information of the object is derived from the position information relating to a detected object in the surrounding environment which is connected thereto.

6. The method according to claim 2, wherein an actual distance and/or an actual angle are ascertained from the actual position and/or the actual orientation and/or from the position information of a detected object, wherein the actual distance characterizes how far away the coupling element on the towing vehicle is from the coupling element on the trailer, and the actual angle characterizes how the coupling element on the towing vehicle is aligned with respect to the coupling element on the trailer.

7. The method according to claim 6, wherein the positioning information indicates that the trailer coupling might be in the locked state if the actual distance has reached a setpoint distance.

8. The method according to claim 6, wherein, in the event that the actual angle exceeds a limit angle, the positioning information indicates that the trailer coupling might not be in the locked state, wherein the limit angle is selected such that, if the limit angle is exceeded, it is no longer possible to couple the coupling element on the trailer to the coupling element on the towing vehicle.

9. The method according to claim 1, wherein the coupling information indicates that the trailer coupling might be in the locked state if, from a movement of the locking mechanism of the trailer coupling and/or from a control signal of an electrical actuating mechanism for actuating the locking element, it follows that the locking mechanism is in a closed position.

10. The method according to claim 1, wherein, to ascertain the coupling information, the jolt of the towing vehicle and/or the jolt of the trailer is ascertained via:
a velocity sensor on the towing vehicle and/or on the trailer, and/or
an acceleration sensor on the towing vehicle and/or on the trailer.

11. The method according to claim 1, wherein the coupling information indicates that the trailer coupling might be in the locked state if the jolt of the towing vehicle and the jolt of the trailer indicate that the coupling element on the trailer has made contact with the coupling element on the towing vehicle, in that the jolt of the towing vehicle and the jolt of the trailer reach or exceed a jolt limit value.

12. The method according to claim 1, wherein the coupling information and the positioning information are ascertained in succession or in parallel with one another.

13. The method according to claim 1, wherein the positioning information is only ascertained if the coupling information indicates that the trailer coupling might be in the locked state, or vice versa.

14. The method according to claim 1, wherein the coupling outcome indicates that a pivotal connection between the towing vehicle and the trailer is established if both the coupling information and the positioning information indicate that the trailer coupling might be in the locked state.

15. The method according to claim 1, wherein, if both the coupling information and the positioning information indicate that the trailer coupling might be in the locked state, it is additionally ascertained whether the jolt of the towing vehicle and/or the jolt of the trailer vehicle reach or exceed a specified jolt threshold value, in particular within a time offset after the towing vehicle has started to move, and the coupling outcome indicates that a pivotal connection between the towing vehicle and the trailer is established if the specified jolt threshold value has been reached.

16. A state-ascertaining arrangement for ascertaining a coupling state of a trailer coupling between a towing vehicle and a trailer, in particular according to the method according to claim 1, the state-ascertaining arrangement comprising:
a position sensor for ascertaining a position of a locking mechanism of the trailer coupling, and/or
an acceleration sensor on the towing vehicle and/or the trailer for ascertaining a jolt of the towing vehicle and/or a jolt of the trailer, and/or
a velocity sensor on the towing vehicle and/or on the trailer for ascertaining a jolt of the towing vehicle and/or a jolt of the trailer;
a wave-based sensor device for detecting objects in a surrounding environment and for outputting sensor signals; and
a state-ascertaining unit, wherein the state-ascertaining unit is configured to:
ascertain coupling information, wherein, depending on the position of the locking mechanism of the trailer coupling and/or the jolt of the towing vehicle and/or the jolt of the trailer vehicle, the coupling information indicates whether the trailer coupling might be in the locked state,
ascertain positioning information, wherein, depending on sensor signals of the wave-based sensor device, the positioning information indicates whether the trailer coupling might be in the locked state, and
ascertain a coupling outcome depending on the coupling information and the positioning information, wherein the coupling outcome indicates whether or not a pivotal connection between the towing vehicle and the trailer is established via the trailer coupling.

17. The state-ascertaining arrangement according to claim 16, wherein the wave-based sensor device has a camera and/or a LiDAR sensor and/or a radar sensor and/or an ultrasonic sensor.

18. A vehicle, in particular utility vehicle, comprising:
a towing vehicle;
a trailer,
wherein a pivotal connection between a towing-vehicle coupling element on the towing vehicle and a trailer coupling element on the trailer is established via a trailer coupling if a locking mechanism of the trailer coupling is brought into a closed position; and
the state-ascertaining arrangement according to claim 16 for ascertaining a coupling state of the trailer coupling.

19. The vehicle according to claim 18, wherein the trailer coupling is:
configured as a pin coupling, in which, to establish a pivotal connection, an eye on a drawbar as a coupling element on the trailer is configured to be held in a clevis as a coupling element on the towing vehicle via a coupling pin as a locking mechanism, or
configured as a fifth wheel coupling, in which, to establish a pivotal connection, a kingpin as a coupling element on the trailer is configured to be held on a fifth wheel plate as a coupling element on the towing vehicle via a coupling dog as a locking mechanism.
